(19) United States
(12) Patent Application Publication
(10) Pub. No.: US 2005/0274393 A1
(43) Pub. Date: Dec. 15, 2005

(54) Wafer clean process

(75) Inventors: Baw-Ching Perng, Hsin-chu (TW); Hun-Jan Tao, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/866,325

(22) Filed: Jun. 9, 2004

(51) Int. Cl. C23G 1/00; B08B 7/00

(52) U.S. Cl. 134/2; 134/33

(57) ABSTRACT

A novel process for cleaning a semiconductor wafer is disclosed. The process of the invention reduces or eliminates charge-up damage caused by friction which is generated between the wafer and rinsing water or other fluid as the wafer is rotated during the cleaning process. In one embodiment of the invention, the wafer is placed on a rotatable chuck or support inside a cleaning chamber. An ion-forming gas is introduced into the chamber as the cleaning fluid is dispensed onto the wafer. The gas increases the electrical conductivity of the cleaning fluid by forming ions in the fluid, thereby reducing or eliminating cleaning fluid charge-up and preventing breakdown of dielectric materials and/or corrosion of metal on the wafer. In another embodiment, the gas is dissolved in the cleaning fluid, which is dispensed on the rotating wafer. In still another embodiment, the cleaning fluid is heated and then dispensed onto the wafer.

### FIELD OF THE INVENTION

The present invention relates to processes for cleaning residues from a semiconductor wafer during the fabrication of integrated circuits on the wafer. More particularly, the present invention relates to a wafer clean process in which friction between a wafer and a cleaning medium such as deionized (DI) water is reduced to decrease charge-up dielectric film breakdown and metal corrosion during wafer cleaning.

### BACKGROUND OF THE INVENTION

The fabrication of various solid state devices requires the use of planar substrates, or semiconductor wafers, on which integrated circuits are fabricated. The final number, or yield, of functional integrated circuits on a wafer at the end of the IC fabrication process is of utmost importance to semiconductor manufacturers, and increasing the yield of circuits on the wafer is the main goal of semiconductor fabrication. After packaging, the circuits on the wafers are tested, wherein non-functional dies are marked using an inking process and the functional dies on the wafer are separated and sold. IC fabricators increase the yield of dies on a wafer by exploiting economies of scale. Over 1000 dies may be formed on a single wafer which measures from six to twelve inches in diameter.

Various processing steps are used to fabricate integrated circuits on a semiconductor wafer. These steps include deposition of a conducting layer on the silicon wafer substrate; formation of a photoresist or other mask such as titanium oxide or silicon oxide, in the form of the desired metal interconnection pattern, using standard lithographic or photolithographic techniques; subjecting the wafer substrate to a dry etching process to remove the conducting layer from the areas not covered by the mask, thereby etching the conducting layer in the form of the masked pattern on the substrate; removing or stripping the mask layer from the substrate typically using reactive plasma and chlorine gas, thereby exposing the top surface of the conductive interconnect layer; and cooling and drying the wafer substrate by applying water and nitrogen gas to the wafer substrate.

The numerous processing steps outlined above are used to cumulatively apply multiple electrically conductive and insulative layers on the wafer and pattern the layers to form the circuits. The final yield of functional circuits on the wafer depends on proper application of each layer during the process steps. Proper application of those layers depends, in turn, on coating the material in a uniform spread over the surface of the wafer in an economical and efficient manner.

In the semiconductor industry, copper is being increasingly used as the interconnect material for microchip fabrication. The conventional method of depositing a metal conducting layer and then etching the layer in the pattern of the desired metal line interconnects and vias cannot be used with copper because copper is not suitable for dry-etching. Special considerations must also be undertaken in order to prevent diffusion of copper into silicon during processing. Therefore, the dual-damascene process has been developed and is widely used to form copper metal line interconnects and vias in semiconductor technology. In the dual-damascene process, the dielectric layer rather than the metal layer is etched to form trenches and vias, after which the metal is deposited into the trenches and vias to form the desired interconnects. Finally, the deposited copper is subjected to chemical mechanical planarization (CMP) to remove excess copper (copper overburden) extending from the trenches.

While there exist many variations of a dual-damascene process flow, the process typically begins with deposition of a silicon dioxide dielectric layer of desired thickness which corresponds to the thickness for the via or vias to be etched in the dielectric layer. Next, a thin etch stop layer, typically silicon nitride, is deposited on the dielectric layer. Photolithography is then used to pattern via openings over the etch stop layer, after which dry etching is used to etch via openings in the etch stop layer. The patterned photoresist is then stripped from the etch stop layer after completion of the etch.

A remaining dielectric layer, the thickness of which corresponds to the thickness of the trench for the metal interconnect lines, is then deposited on the etch stop layer. Photolithography, followed by dry etching, is used to pattern the trenches in the remaining dielectric layer and the vias beneath the trenches. The trench etching stops at the etch stop layer, while the vias are etched in the first dielectric layer through the openings in the etch stop layer and beneath the trenches. Next, a barrier material of Ta or TaN is deposited on the sidewalls and bottoms of the trenches and vias using ionized PVD. A uniform copper seed layer is then deposited on the barrier layer using CVD.

After the trenches and vias are filled with copper, the copper overburden extending from the trenches is removed and the upper surfaces of the metal lines planarized using CMP. In the dual damascene process described above, the vias and the trenches are etched in the same step, and the etch stop layer defines the bottom of the trenches. In other variations, the trench is patterned and etched after the via.

A significant advantage of the dual-damascene process is the creation of a two-leveled metal inlay which includes both via holes and metal line trenches that undergo copper fill at the same time. This eliminates the requirement of forming the trenches for the metal interconnect lines and the holes for the vias in separate processing steps. The process further eliminates the interface between the vias and the metal lines.

Another important advantage of the dual-damascene process is that completion of the process typically requires 20% to 30% fewer steps than the traditional aluminum metal interconnect process. Furthermore, the dual damascene process omits some of the more difficult steps of traditional aluminum metallization, including aluminum etch and many of the tungsten and dielectric CMP steps. Reducing the number of process steps required for semiconductor fabrication significantly improves the yield of the fabrication process, since fewer process steps translate into fewer sources of error that reduce yield.

In the photoresist strip step, a hot acid solution is typically applied to the photoresist. This is followed by application of an organic solvent to remove residual photoresist from the wafer. The wafer is then subjected to a spin-rinse step, in which the wafer is rotated on a wafer chuck or support and a rinsing liquid such as deionized (DI) water is dispensed onto the wafer.

Due to the low electrical conductivity of the DI water used in the spin-rinse step of wafer cleaning, friction induced between the rotating wafer and the rinsing DI water induces charge-up damage to the wafer. This friction-induced charge-up damage introduces film breakdown into low-k dielectric materials deposited on the wafer, and further, causes copper corrosion. Therefore, a new and improved wafer clean process is needed for reducing the charge-up damage induced by friction which is generated between a rotating wafer and rinsing water during the process.

Accordingly, an object of the present invention is to provide a novel process for cleaning a semiconductor wafer.

Another object of the present invention is to provide a novel process which is particularly suitable for cleaning a semiconductor wafer during a dual damascene process.

Still another object of the present invention is to provide a novel wafer clean process which reduces charge-up damage induced by friction generated by a rotating wafer and a cleaning fluid during the process.

Yet another object of the present invention is to provide a novel wafer clean process which includes dissolving an ion-forming gas in a cleaning fluid to increase the electrical conductivity of the fluid and reduce charge-up damage induced by friction generated between the rotating wafer and the cleaning fluid.

A still further object of the present invention is to provide a novel wafer clean process which includes raising the temperature of a cleaning fluid prior to dispensing the fluid onto a wafer in order to reduce the viscosity of the fluid and reduce or eliminate charge-up damage induced by friction generated between the rotating wafer and the cleaning fluid.

### SUMMARY OF THE INVENTION

In accordance with these and other objects and advantages, the present invention is directed to a novel process for cleaning a semiconductor wafer. The process of the invention reduces or eliminates charge-up damage caused by friction which is generated between the wafer and rinsing water or other fluid as the wafer is rotated during the cleaning process. In a first embodiment of the invention, the wafer is placed on a rotatable chuck or support inside a cleaning chamber. An ion-forming gas is introduced into the chamber as the cleaning fluid is dispensed onto the wafer. The gas increases the electrical conductivity of the cleaning fluid by forming ions in the fluid, thereby reducing or eliminating cleaning fluid charge-up and preventing breakdown of dielectric materials and/or corrosion of metal on the wafer.

In a second embodiment of the invention, the conductivity of the cleaning fluid is increased by dissolving the ion-forming gas in the cleaning fluid through electrical discharge and mixing. The cleaning fluid is then dispensed onto the wafer to remove particulate residues from the wafer. In a third embodiment of the invention, the conductivity of the cleaning fluid is increased by dissolving the ion-forming gas in the cleaning fluid through bubbling and mixing. In a fourth embodiment of the invention, the viscosity of the cleaning fluid is reduced by raising the temperature of the cleaning fluid prior to dispensing the cleaning fluid onto the wafer.

### BRIEF DESCRIPTION OF THE DRAWINGS

The invention will now be described, by way of example, with reference to the accompanying drawings, in which:

FIG. 1 is a schematic of a spin-rinse clean chamber in implementation of one embodiment of the process of the present invention;

FIG. 2 is a schematic of a spin-rinse clean system in implementation of another embodiment of the process of the present invention, more particularly illustrating dissolving of an ion-forming gas in a cleaning fluid by electrical discharge, followed by dispensing of the cleaning fluid onto a wafer;

FIG. 3 is a schematic of a spin rinse clean system in implementation of another embodiment of the process of the present invention, more particularly illustrating dissolving of an ion-forming gas in a cleaning fluid by bubbling and mixing, followed by dispensing of the cleaning fluid onto a wafer, according to a third embodiment of the present invention;

FIG. 4 is a flow diagram which summarizes sequential process steps according to the embodiment of the invention shown in FIG. 1;

FIG. 5 is a flow diagram which summarizes sequential process steps according to the embodiments of the invention shown in FIGS. 2 and 3;

FIG. 6 is a flow diagram which summarizes sequential process steps according to an additional embodiment of the invention;

FIG. 7A is a cross-section of a partially-fabricated dual damascene structure, wherein a patterned photoresist layer is provided on an upper dielectric layer prior to implementation of the process of the present invention;

FIG. 7B is a cross-section of a partially-fabricated dual damascene structure, wherein the patterned photoresist layer is stripped from the upper dielectric layer prior to implementation of the process of the present invention; and

FIG. 8 is a schematic of a spin-rinse clean system in implementation of another embodiment of the process of the present invention.

### DETAILED DESCRIPTION OF THE INVENTION

The present invention is directed to a novel process for cleaning a semiconductor wafer in such a manner that charge-up damage to dielectric and/or metal layers, caused by friction which is generated between the rotating wafer and rinsing or cleaning water or other fluid, is eliminated or substantially reduced. According to a first embodiment of the invention, the wafer is placed on a rotatable chuck or support inside a cleaning chamber. An ion-forming gas is then introduced into the chamber, either before or as the cleaning fluid is dispensed onto the wafer. The gas is dissolved in the fluid and forms ions, thereby increasing the electrical conductivity of the cleaning fluid. This, in turn, reduces or substantially eliminates friction-induced cleaning fluid charge-up and prevents or substantially reduces breakdown of dielectric materials, particularly those having a low dielectric constant (k), and/or corrosion of metal on the wafer.

According to a second embodiment of the invention, the ion-forming gas is dissolved in the cleaning fluid through electrical discharge and mixing. As it is dispensed onto the wafer, the cleaning fluid removes particulate residues from the wafer while reducing or eliminating friction-induced charge-up of the cleaning fluid. According to a third embodiment of the invention, a bubbling and mixing process is used to dissolve the ion-forming gas in the cleaning fluid and increase the electrical conductivity of the fluid.

Any of a variety of ion-forming gases may be used to increase the electrical conductivity of the cleaning fluid. Ion-forming gases which are suitable for implementation of the present invention include O₂, O₃, N₂, CO₂, Ar and air. The mole fraction solubilities of these gases are as follows: O₂ (2.29×10⁻⁵); O₃ (1.89×10⁻⁶); N₂ (1.18×10⁻⁵); CO₂ (6.15×10⁻⁴); and Ar (2.52×10⁻⁵).

According to a fourth embodiment of the invention, the temperature of the cleaning fluid is raised to reduce the viscosity of the cleaning fluid prior to dispensing the cleaning fluid onto the wafer. Preferably, DI water is used as the cleaning fluid. The viscosity of DI water vs. temperature is shown in Table (I) below.

TABLE I

| Temperature | Viscosity (μ Pa s) |
|---|---|
| 20° C. | 1002 |
| 30° C. | 797.7 |
| 40° C. | 653.2 |
| 60° C. | 466.5 |
| 80° C. | 354.4 |
| 100° C. | 281.8 |

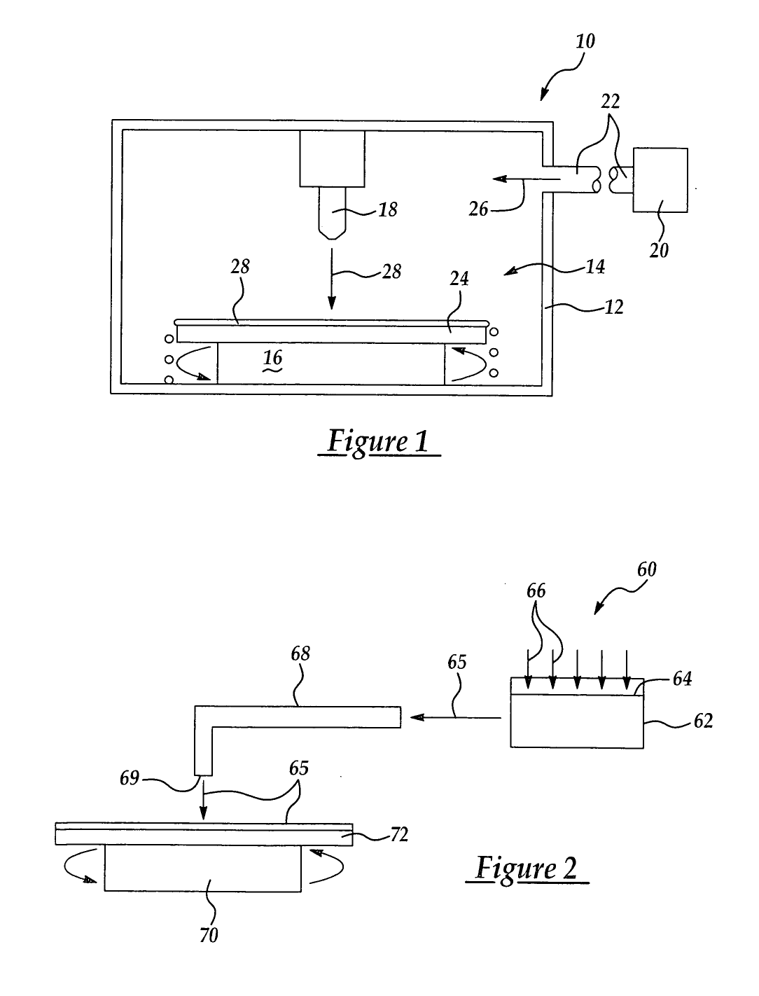

Referring initially to FIG. 1, according to a first embodiment of the present invention, a spin-rinse clean chamber 10 which is suitable for implementation of the present invention is shown. The spin-rinse chamber 10 includes a chamber wall 12 that defines a chamber interior 14. A wafer chuck 16, which supports a semiconductor wafer 24, is mounted for rotation in the chamber interior 14. At least one fluid dispensing nozzle 18 is provided in the chamber interior 14, above the wafer chuck 16. In operation of the chamber 10, as hereinafter described, a cleaning fluid 28, typically DI water, is dispensed onto the semiconductor wafer 24 as the wafer chuck 16 rotates the wafer 24.

A gas source 20 is provided in fluid communication with the chamber interior 14 through a gas inlet conduit 22. The gas source 20 contains an ion-forming gas 26, such as O₂, O₃, N₂, CO₂, Ar or air, in non-exclusive particular. The ion-forming gas 26 combines with and is dissolved in the cleaning fluid 28 as the fluid 28 is dispensed onto the rotating wafer 24, as hereinafter further described.

Referring next to FIGS. 7A and 7B, a typical dual damascene structure 40 (FIG. 7A) includes a semiconductor wafer 24; one or multiple metal lines 46, typically copper or AlCu, formed on the wafer 24; a bottom dielectric layer 44 deposited on the wafer 24 and metal lines 46; an etch stop layer 48 provided on the bottom dielectric layer 44; an upper dielectric layer 50 provided on the etch stop layer 48; and a patterned photoresist layer 52, which may be an organic photoresist, provided on the upper dielectric layer 50, as shown in FIG. 7A.

The structure 40 further includes a bottom stop layer (not shown) having a thickness of typically less than about 600 angstroms. The bottom stop layer may be characterized by a carbon-containing silicon oxide. Alternatively, the bottom stop layer may be characterized by a nitrogen-containing silicon oxide.

The bottom dielectric layer 44 and the upper dielectric layer 50 is each preferably a low-k dielectric material having a dielectric constant of typically less than about 3.7. Preferably, the low-k dielectric material contains carbon, fluorine or both carbon and fluorine.

According to the pattern of the photoresist layer 52, one or multiple trenches 54 are etched in the upper dielectric layer 50, and one or multiple vias 56 are etched in the lower dielectric layer 44, as shown in FIG. 7B. The photoresist layer 52 (shown in phantom in FIG. 7B) is then stripped from the upper dielectric layer 50, after which a solvent (not shown) is typically applied to the structure 40 to dissolve and remove residual organic photoresist particles. The solvent may be an organic solvent, an inorganic acid solvent or a DI-O3 solvent. The process of the present invention is directed to a wafer cleaning or rinsing process which may be carried out to remove residual photoresist particles which remain on the dual damascene structure 40 after the solvent-exposure step. However, it is understood that the process of the present invention is more generally applicable to the cleaning or rinsing of semiconductor wafers at any stage of integrated circuit fabrication where such cleaning or rinsing is deemed necessary.

Referring to FIG. 1, in conjunction with the flow diagram of FIG. 4, in implementation of a first embodiment of the present invention, the semiconductor wafer 24, which may include the dual damascene structure 40 shown in FIG. 7B, is initially cleaned with solvent to dissolve and remove residual photoresist particles from the wafer, as indicated in process step 1 of FIG. 4. The wafer 24 is then placed in the chamber interior 14, on the wafer chuck 16 of the spin-rinse clean chamber 10, as shown in FIG. 1 and indicated in process step 2 of FIG. 4. The ion-forming gas 26, which is typically O₂, O₃, N₂, CO₂, Ar or air, is then introduced into the chamber interior 14, from the gas source 20 to form an ion-forming gas ambient in the chamber interior 14, as indicated in process step 3 of FIG. 4.

Next, the cleaning fluid 28, typically DI water, is dispensed from the nozzle 18, onto the wafer 24 as the wafer chuck 16 rotates the wafer 24 at a rotational speed of typically less than about 700 rpm (step 4 of FIG. 4). The ion-forming gas 26 in the chamber interior 14 dissolves in the cleaning fluid 28 on the wafer 24. As the wafer chuck 16 rotates the wafer 24, the ion-forming gas 26 increases the electrical conductivity of the cleaning fluid 28, thereby decreasing the frictional force between the cleaning fluid 28 and the rotating wafer 24. This, in turn, reduces the electrical charge-up of the cleaning fluid 28, thereby reducing or eliminating breakdown of the dielectric layers 44, 50 (FIG. 7B) on the wafer 24, as well as the metal lines 46 exposed by the trenches 54 and vias 56 of the dual damascene structure 40.

Referring next to FIGS. 2 and 5, in another embodiment of the process of the present invention, a spin-rinse clean system 60 is provided. The system 60 includes a fluid tank 62 which contains a supply of cleaning fluid 64, such as DI water. A dispensing arm 68 is provided in fluid communication with the fluid tank 62. A discharge end 69 of the dispensing arm 68 is positioned above a rotatable wafer chuck 70.

According to the process of the present invention, a wafer 72 is typically initially cleaned using an organic solvent (step 1a of FIG. 5), such as in a dual damascene process heretofore described with respect to FIGS. 7A and 7B, for example. Next, an ion-forming gas 66, such as O₂, O₃, N₂, CO₂, Ar or air, for example, is dissolved in and mixed with the cleaning fluid 64 (step 2a of FIG. 5). This step is carried out typically using an electrical discharge process, such as a corona discharge process known by those skilled in the art, for example.

As indicated in step 3a, the gas-containing cleaning fluid 65 is then pumped from the fluid tank 62, through the dispensing arm 68 and ejected onto the wafer 72 from the discharge end 69 as the wafer chuck 70 rotates the wafer 72 at a rotational speed of typically less than about 700 rpm. As the wafer chuck 70 rotates the wafer 72, the ion-forming gas 66 increases the electrical conductivity of the gas-containing cleaning fluid 65 dispensed on the wafer 72, thereby decreasing the frictional force between the gas-containing cleaning fluid 65 and the wafer 72 and reducing or eliminating breakdown of dielectric layers and corrosion of metal lines on the wafer.

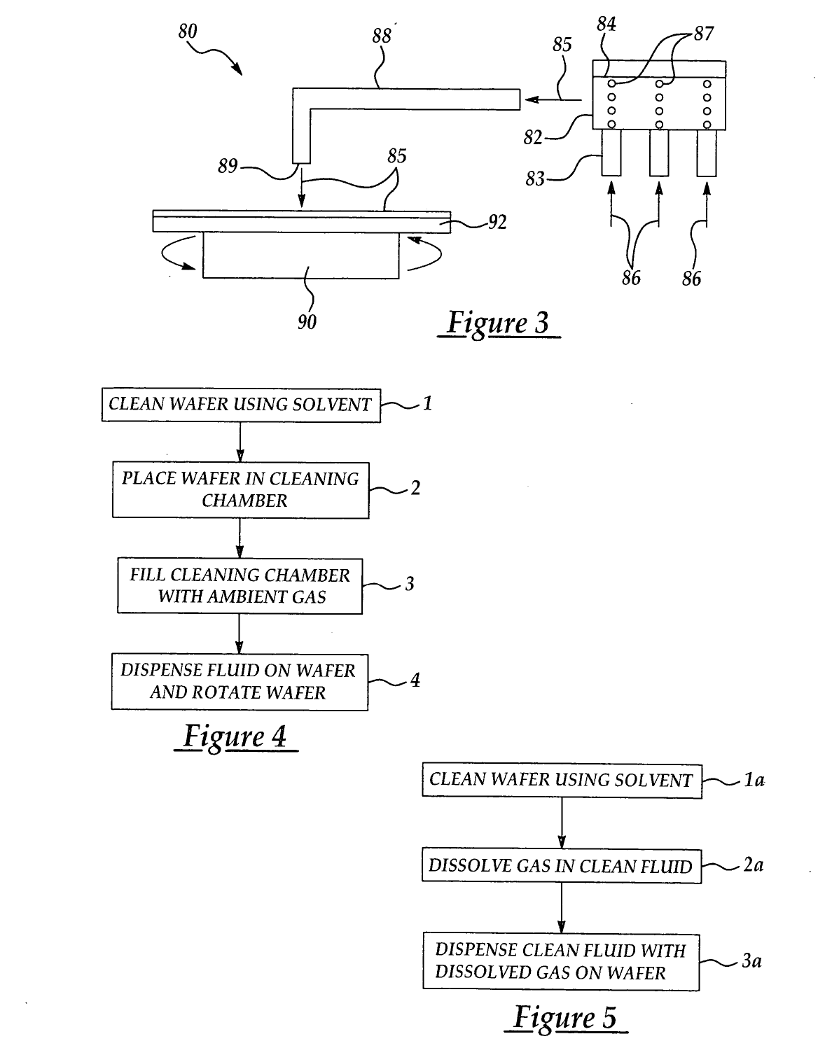

Referring next to FIGS. 3 and 5, in still another embodiment of the process of the present invention, a spin-rinse clean system 80 is provided. The system 80 includes a fluid tank 82 which contains a supply of cleaning fluid 84, preferably DI water. Multiple conduits 83 may be provided in fluid communication with the fluid tank 82. A dispensing arm 88 is provided in fluid communication with the fluid tank 82. A discharge end 89 of the dispensing arm 88 is positioned above a rotatable wafer chuck 90 which supports a wafer 92.

According to the process of the present invention, a cleaning fluid 84, preferably DI water, is placed in the fluid tank 82. An ion-forming gas 86, such as O₂, O₃, N₂, CO₂, Ar or air, for example, is dissolved in the cleaning fluid 84. This is carried out by bubbling the ion-forming gas 86 through the cleaning fluid 84 as gas bubbles 87, such as by introducing the ion-forming gas 86 into the fluid tank 82 through the conduits 83, for example.

As indicated in step 1a of FIG. 5, the wafer 92 is typically initially cleaned using an organic solvent, such as during a dual damascene process, for example, as heretofore described with respect to FIGS. 7A and 7B. The wafer 92 is then placed on the wafer chuck 90 of the system 80. Next, as indicated in step 2a and shown in FIG. 3, the ion-forming gas 86 is dissolved in the cleaning fluid 84 typically by bubbling gas bubbles 87 through the cleaning fluid 84. The gas-containing cleaning fluid 85 is then distributed from the fluid tank 82, through the dispensing arm 88 and dispensed onto the wafer 92 through the discharge end 89, as the wafer chuck 90 rotates the wafer 92 at a rotational speed of typically less than about 700 rpm. As the wafer chuck 90 rotates the wafer 92, the ion-forming gas 86 increases the electrical conductivity of the gas-containing cleaning fluid 85 dispensed on the wafer 92. This decreases the frictional force between the gas-containing cleaning fluid 85 and the rotating wafer 92, reducing or eliminating breakdown of dielectric layers and corrosion of metal lines on the wafer.

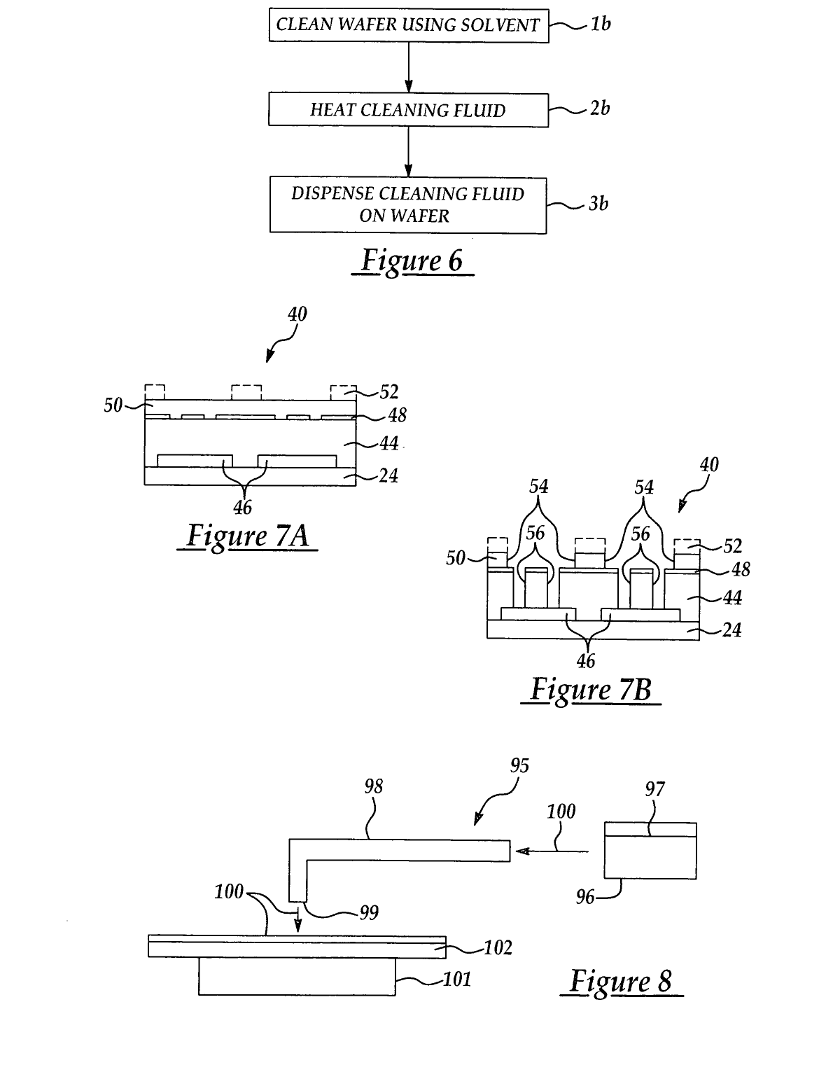

Referring next to FIGS. 6 and 8, in still another embodiment of the process of the present invention, a spin rinse clean system 95 is provided and includes a fluid heating tank 96 for containing and heating a cleaning fluid 97, preferably DI water. A dispensing arm 98 is provided in fluid communication with the fluid tank 96. A discharge end 99 of the dispensing arm 98 is positioned above a rotatable wafer chuck 101 which supports a wafer 102.

According to the process of the present invention, the wafer 102 is initially cleaned using solvent, such as during a dual damascene process, as indicated in step 1b of FIG. 6, and then placed on the wafer chuck 101 of the system 95. The cleaning fluid 97 is initially heated in the fluid tank 96 to a temperature of at least about 50 degrees C., and preferably, about 80-100 degrees C. The wafer chuck 101 may also be fitted with a suitable heating mechanism to heat the wafer 102 to a temperature of typically at least about 50 degrees C. The heated cleaning fluid 97 is then dispensed from the fluid tank 96, through the dispensing arm 98 and discharge end 99 and onto the wafer 102. Simultaneously, the wafer chuck 101 rotates the wafer 102 at a rotational speed of typically less than about 700 rpm.

As the wafer chuck 101 rotates the wafer 102, the heated cleaning fluid 100 dispensed onto the wafer 92 has a relatively low viscosity (preferably less than about 400 μPa s). This results in a relatively small frictional force between the heated cleaning fluid 100 and the wafer 102 and reduces or eliminates breakdown of dielectric layers and corrosion of metal lines on the wafer.

While the preferred embodiments of the invention have been described above, it will be recognized and understood that various modifications can be made in the invention and the appended claims are intended to cover all such modifications which may fall within the spirit and scope of the invention.

1. A method for cleaning a wafer, comprising:
providing a cleaning fluid;
dissolving an ion-forming gas in said cleaning fluid;
rotating said wafer; and
dispensing said cleaning fluid onto said wafer.

2. The method of claim 1 wherein said ion-forming gas is O₂, O₃, N₂, CO₂, Ar or air.

3. The method of claim 1 wherein said cleaning fluid comprises deionized water.

4. The method of claim 2 wherein said ion-forming gas is dissolved in said cleaning fluid through electrical discharge and mixing.

5. The method of claim 2 wherein said ion-forming gas is dissolved in said cleaning fluid through bubbling and mixing.

6. The method of claim 2 wherein said dissolving an ion-forming gas in said cleaning fluid comprises providing a chamber, placing said wafer in said chamber and introducing said ion-forming gas into said chamber during said dispensing said cleaning fluid onto said wafer.

7. The method of claim 1 wherein said ion-forming gas has a gas mole fraction solubility of over about 1×10⁻⁶ at room temperature.

8. The method of claim 1 wherein said wafer includes at least one dielectric layer having a dielectric constant of less than about 3.7.

9. The method of claim 8 wherein said at least one dielectric layer comprises carbon.

10. The method of claim 8 wherein said at least one dielectric layer comprises fluorine.

11. The method of claim 1 wherein said rotating said wafer comprises rotating said wafer at a rotational speed of less than about 700 rpm.

12. The method of claim 1 wherein said cleaning fluid has a temperature of from about 60 degrees C. to about 100 degrees C.

13. The method of claim 1 further comprising a damascene structure provided on said wafer.

14. The method of claim 13 wherein said damascene structure includes a bottom stop layer having a thickness of less than about 600 angstroms.

15. The method of claim 13 wherein said damascene structure includes a bottom stop layer comprising carbon-containing silicon oxide.

16. The method of claim 13 wherein said damascene structure includes a bottom stop layer comprising nitrogen-containing silicon oxide.

17. A method for cleaning a wafer, comprising:
applying a solvent to said wafer;
providing a cleaning fluid;
dissolving an ion-forming gas in said cleaning fluid;
rotating said wafer; and
dispensing said cleaning fluid onto said wafer.

18. The method of claim 17 wherein said solvent is a solvent selected from the group consisting of an organic solvent and an inorganic acid solvent.

19. A method for cleaning a wafer, comprising:
providing deionized water;
providing a viscosity of less than about 500 μPa s to said deionized water;
rotating said wafer; and
dispensing said deionized water onto said wafer.

20. The method of claim 19 wherein said deionized water has a temperature of at least about 50 degrees C.

21. The method of claim 20 further comprising heating said wafer to said temperature.
